(19) United States
(12) Patent Application Publication
(10) Pub. No.: US 2023/0249013 A1
(43) Pub. Date: Aug. 10, 2023

(54) SYSTEM FOR INTRODUCING BREATHABLE AIR AT FACE MASK

(71) Applicant: Kathy E. Goodman DO, Inc., Delray Beach, FL (US)

(72) Inventor: Kathy E. Goodman, Delray Beach, FL (US)

(21) Appl. No.: 17/668,478

(22) Filed: Feb. 10, 2022

(51) Int. Cl. A62B 23/02; A62B 7/12; A41D 13/11

(52) U.S. Cl. CPC A62B 23/02; A62B 7/12; A41D 13/11; B60N 3/00

(57) ABSTRACT

A system for introducing breathable air at a face mask worn by a person includes a wearable manifold and a flexible conduit. The manifold has an inlet port adapted to receive a supply of breathable air and an outlet port. The flexible conduit has a first open end and a second open end. The first open end is coupled to the outlet port of the manifold, and the second open end is adapted to be placed between the person's face and a face mask worn by the person.

### FIELD OF THE INVENTION

The invention relates generally to supplemental devices used with face masks, and more particularly to a system for introducing breathable air between a face mask and the face mask wearer in order to improve the breathing experience of the face mask wearer.

### BACKGROUND OF THE INVENTION

In 2020, the outbreak of the COVID-19 virus alerted the world to the potentially deadly nature of airborne infectious pathogens. When such airborne infectious pathogens are readily transmitted by humans via their aerosolized particles expelled during breathing, speech, singing, coughing, sneezing, etc., anyone in the proximity of the aerosolized particles can be infected. The risk of infection is greatly increased when people share an enclosed environment such as those defined by aircraft, land vehicles, enclosed spaces/rooms, and/or relatively open but heavily-populated environments (e.g., airports, terminals, arenas or stadiums, amusement parks, subway and train platforms, etc.).

The recent awareness of the health risks posed by airborne infectious pathogens has also highlighted the need to protect oneself from other airborne particles that can present long-term health risks. Indeed, many work environments routinely and consistently expose inhabitants thereof to a variety of airborne particles that include man-made contaminants, dust, and dirt over the course of a work day. For example, construction workers routinely work in dirty and dusty environments, painters using sprayers are routinely exposed to clouds of aerosolized paint particles, etc.

Currently, when in any environment that presents a high risk of inhalation of airborne infectious pathogens, man-made contaminants, dust, dirt, etc., medical and science experts advise people to wear a face mask that covers one's nose and mouth. While face masks are effective at greatly reducing airborne pathogen transmission and/or inhalation of health-damaging particles, face masks can make breathing more difficult and can be uncomfortable when worn for extended periods. In addition, the air one breathes when wearing a mask never feels like “fresh air”. Thus, the drawbacks of mask wearing frequently lead to incorrect wearing of masks and/or their premature removal, both of which negate the advantages of wearing a mask.

### SUMMARY OF THE INVENTION

Accordingly, it is an object of the present invention to provide a system for introducing breathable air at a face mask.

Another object of the present invention is to provide a system for introducing a continuous supply of breathable air for inhalation by a face mask wearer in order to improve the mask wearer's breathing comfort to thereby encourage correct and long-term face mask use.

Other objects and advantages of the present invention will become more obvious hereinafter in the specification and drawings.

In accordance with the present invention, a system for introducing breathable air at a face mask worn by a person includes a manifold and a flexible conduit. The manifold is adapted to be worn by a person, and has an inlet port adapted to receive a supply of breathable air and an outlet port. The flexible conduit has a first open end and a second open end. The first open end is coupled to the outlet port of the manifold. The second open end is adapted to be placed between the person's face and a face mask worn by the person.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of a system for introducing breathable air at a face mask worn by a person in accordance with an embodiment of the present invention;

FIG. 2 is an isolated top plan view of a manifold disposed within a neck pillow/cushion in accordance with an embodiment of the present invention;

FIG. 3 is an isolated front view of a manifold coupled to an ear cushion of a set of headphones in accordance with another embodiment of the present invention;

FIG. 4 is a side view of a flexible conduit used to couple the manifold's outlet port to a region between a face mask and the face of a person wearing the face mask in accordance with an embodiment of the present invention;

FIG. 5A is an end view of the flexible conduit taken along line 5-5 in FIG. 4 illustrating the face-engaging portion of the conduit having a conduit wall configured to adapt to the contours of a person's face in accordance with an embodiment of the present invention;

FIG. 5B is an end view of the flexible conduit taken along line 5-5 in FIG. 4 illustrating the face-engaging portion of the conduit having an elongate cross-sectional shape in accordance with another embodiment of the present invention;

FIG. 6A is a side view of a flexible conduit used to couple the manifold's outlet port to a region between a face mask and the face of a person wearing the face mask with one end of the flexible conduit having a clip to aid in the retention of the conduit at the face mask in accordance with an embodiment of the present invention;

FIG. 6B is a side view of a flexible conduit used to couple the manifold's outlet port to a region between a face mask and the face of a person wearing the face mask with one end of the flexible conduit having a partially annular lip to aid in the retention of the conduit at the face mask in accordance with another embodiment of the present invention;

FIG. 7 is a schematic view of a portion of a manifold having a freezable gel pack fitted in the manifold's inlet port in accordance with another embodiment of the present invention;

FIG. 8 is a schematic view of a portion of a manifold having an air filter fitted in the manifold's inlet port in accordance with another embodiment of the present invention;

FIG. 9 is a schematic view of a portion of a manifold having a fan fitted in the manifold's inlet port in accordance with another embodiment of the present invention;

FIG. 10 is a schematic view of a breathable-air hose that can be used to couple a transport vehicle's filtered-air nozzle to the manifold's inlet port in accordance with an embodiment of the present invention;

FIG. 11 is a side view of a flexible connection housing for the breathable-air hose in accordance with an embodiment of the present invention; and

FIG. 12 is an end view of the flexible connection housing taken along line 12-12 in FIG. 11.

### DETAILED DESCRIPTION OF THE INVENTION

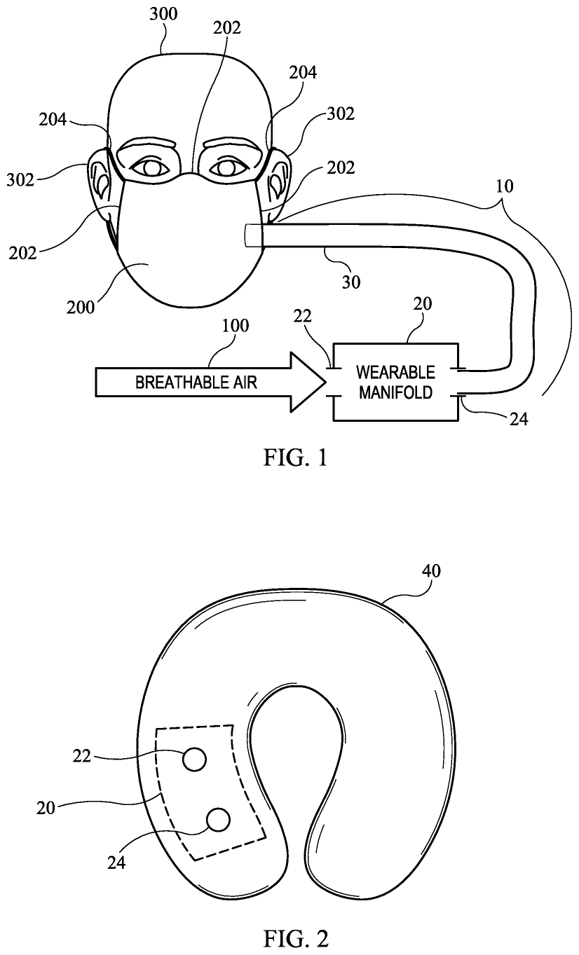

Referring now to the drawings and more particularly to FIG. 1, a system for introducing breathable air 100 at a face mask 200 worn by a person 300 in accordance with an embodiment of the present invention is shown and is referenced generally by numeral 10. Breathable air 100 can originate from a filtered-air source (e.g., a filtered-air nozzle located above one's seat on an aircraft/train/bus, a portable filtered-air supply, etc.), or can originate from a fresh/outdoor air source without departing from the scope of the present invention. In some embodiments of the present invention, a flexible open-ended hose (not shown in FIG. 1) can be provided to supply breathable air 100 from a breathable-air source (not shown) to system 10 as will be described further below.

Face mask 200 can be any of a variety of face mask designs made from one or more layers of cloth, paper, and/or air filtering material. In general, when properly worn, face mask 200 covers the nose and mouth of person 300 and has edges 202 configured for engagement with the face region of person 300 as is well-known in the art. Many such face masks include adjustable-length or elastic loops 204 coupled to edges 202 and wrapped about ears 302 of person 300. Loops 204 aid in the proper positioning and retention of face mask 200. Unfortunately, the proper positioning of face mask 200 causes it to be in close proximity to the person's nose and mouth such that the air filtering properties of face mask 200 also cause breathing comfort issues (i.e., inhalation air that is warm, stale, and not fresh smelling) that ultimately lead to the face mask being moved to an improper position or removed completely. System 10 addresses the breathing comfort issues associated with mask wearing by providing the means to introduce a supply of fresh, filtered, and/or cooled breathable air between face mask 200 and the face of person 300.

System 10 includes a wearable manifold 20 and a flexible conduit 30. In general, manifold 20 is configured to be worn by person 300 (i.e., carried or disposed on or about a portion of the body of person 300 as a covering, equipment, ornament, or the like) and is a collection reservoir for a supply of breathable air 100. Breathable air 100 flows into manifold 20 via an inlet port 22 and can flow out of manifold 20 via an outlet port 24. Additional inlet and/or outlet ports can be provided without departing from the scope of the present invention. In some embodiments of the present invention, breathable air 10 enters manifold 20 under pressure such that a steady flow of the breathable air is delivered to outlet port 24. Generally speaking, flexible conduit 30 is an open-ended and flexible hose or tube that is configured to fit under an edge 202 of face mask 200 such that conduit 30 transports breathable air from outlet port 24 of manifold 20 to a space between face mask 200 and the face of person 300. In this way, person 300 will receive most or all of their air for inhalation via manifold 20 as opposed to drawing inhalation air through face mask 200 thereby virtually eliminating the breathing comfort issues long-associated with mask wearing.

Manifold 20 can be configured as a variety of wearable items or included with or disposed in a housing. The housing could be any of a variety of well-known wearable items having a disparate function already being utilized by person 300. For example and as illustrated in FIG. 2, manifold 20 can be coupled to or disposed within (as illustrated) a cushioned neck pillow 40 typically used by air/train/bus travelers. In this application, inlet port 22 is user accessible and can be coupled to a filtered-air nozzle (not shown) that is typically located over one's seat in an aircraft, train, or bus. The above-described flexible conduit 30 would then be coupled to a user-accessible outlet port 24 and led to a position between the person's face and worn face mask as described above.

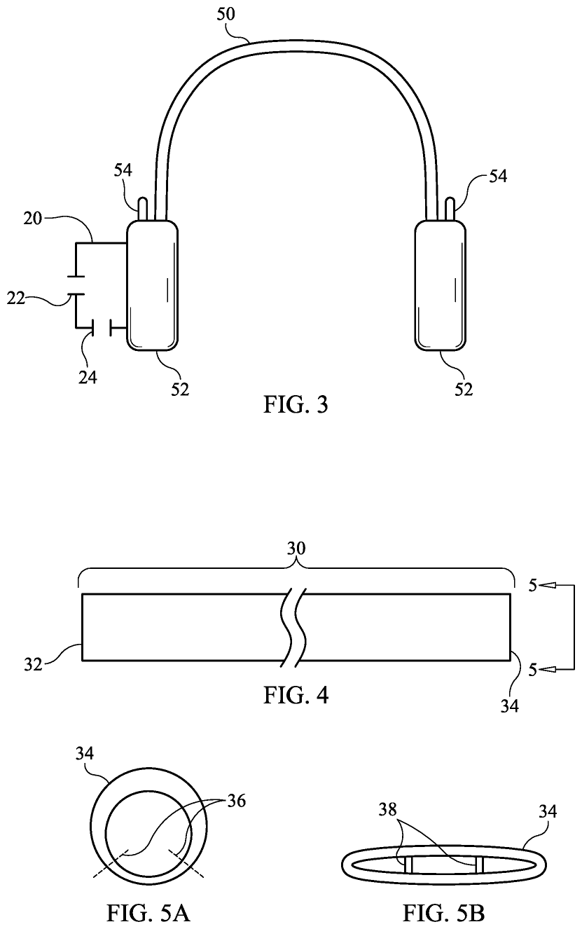

Another type of housing embodiment for manifold 20 is illustrated in FIG. 3 where manifold 20 is coupled to (or, alternatively, disposed in) a portion of a headset 50 having ear cushions 52 that will cover the ears of a person wearing headset 50 as would be understood in the art. Headset 50 could be, for example, a conventional audio headphones or an ear protecting headset worn by workers in loud environments. Manifold 20 could be configured for permanent or temporary attachment to an ear cushion 52 or other part of headset 50 without departing from the scope of the present invention. In some embodiments of the present invention, each of ear cushions 52 can be configured with a recess or channel at the rear thereof (not shown) for engagement with a face mask's ear loops. In other embodiments of the present invention, each of ear cushions 52 can include a pin, stud, or hook 54 for engagement with a face mask's ear loops.

Referring now to FIG. 4, an exemplary embodiment of conduit 30 has open ends 32 and 34. Open end 32 is configured for coupling to outlet port 24 of manifold 20. A variety of permanent or attachable/detachable couplings can be provided at open end 32 without departing from the scope of the present invention. Two goals are associated with the features of open end 34. A first goal is that open end 34 should be configured to minimally impact the interface between a person's face and the worn face mask in order to maintain the seal integrity between the edges of the face mask and the person's face. A second goal is that open end 34 should be configured for comfort where it engages the person's face.

Two exemplary constructions of open end 34 that achieve the above-cited goals are illustrated in FIGS. 5A and 5B presenting end views of open end 34 taken along line 5-5 in FIG. 4. In FIG. 5A, a face-engaging portion/wall of open end 34 between dashed lines 36 can be made to readily adapt to the contours of a person's face at the region of engagement. For example, wall portion 36 in the illustrated example is made thinner that the other wall areas of conduit 30 thereby allowing wall portion 36 readily conform to any facial contours. In FIG. 5B, the cross-sectional shape of open end 34 is an elongate shape that will readily slip between and edge of a face mask and the face of the person wearing the face mask. If needed, cross supports 38 can be provided to keep the two long sides of open end 34 spaced apart from one another to maintain the breathable air there through.

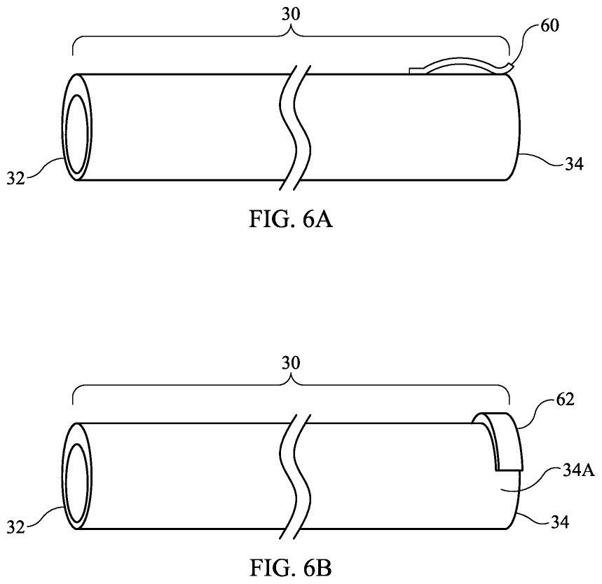

In some embodiments of the present invention, it may be desirable to include or incorporate a retainer at open end 34 of conduit 30 that will actively or passively engage an edge of a person's face mask to aid in the retention of open end 34 at its position under the edge of the face mask as illustrated in FIG. 1. For example, FIG. 6A illustrates a spring clip 60 at open end 34 where clip 60 is used to actively engage with an edge of a face mask as it is being worn by a person. Retention of open end 34 at its position under the edge of a face mask could also be provided in a passive manner. For example and as illustrated in FIG. 6B, a partially annular flange or lip 62 at open end 34 could be provided to passively engage with the edge of face mask being worn by a person. Lip 62 is only provided in a partially annular fashion so that the non-lipped portion 34A of open end 34 can rest comfortably against a person's face.

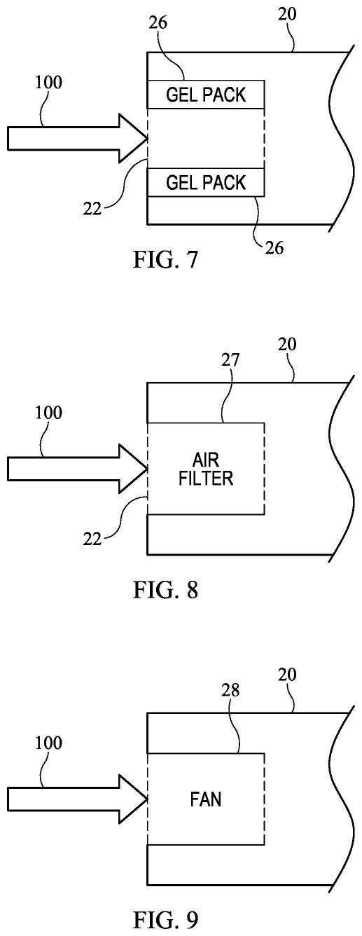

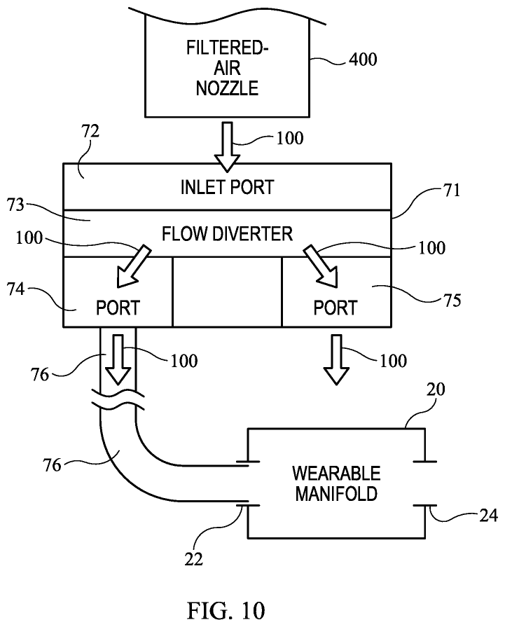

In other embodiments of the present invention, manifold 20 can have one or more additional features to enhance the functionality of the present invention for a particular application. Several exemplary features will be described with the aid of FIGS. 7-9 where each figure presents a schematic view of manifold 20 at its inlet port 22. In FIG. 7, a gel pack 26 of freezable material can be disposed in inlet port 22 to cool breathable air 100 as it enters manifold 20. For example, gel pack 26 can be configured as a sleeve that can be removably installed in inlet port 22 or permanently installed therein without departing from the scope of the present invention. Prior to use, gel pack 26 (or manifold 20 with gel pack 26 installed therein) is refrigerated to freeze the material in gel pack 26. Then, in use, breathable air 100 entering manifold 20 is cooled prior to exiting the manifold's outlet port as described earlier herein. The cooled breathable air improves the person's breathing experience through the provision of a continuous supply of cooled breathable air. Provisions can be made to store additional/replacement gel packs on manifold 20 or its supporting housing. FIG. 8 illustrates manifold 20 having an air filter 27 disposed in inlet port 22 to, for example, filter out particulates of desired size. FIG. 9 illustrates manifold 20 having a fan 28 disposed in inlet port 22 to control the pressure of breathable air 100 introduced into manifold 20 as a means to control the force of the breathable air exiting the manifold's outlet port as described above.

As mentioned above, the present invention can receive its breathable air from a filtered-air nozzle that is typically located above one's seat of a transport vehicle such as an aircraft, train, or bus. For such applications, the present invention can also include a breathable-air hose for coupling a transport vehicle's filtered-air nozzle to the inlet port of the present invention's wearable manifold. Since the amount of air dispensed from a filtered-air nozzle is generally more than what is needed for comfortable breathing, the breathable-air hose of the present invention will include a nozzle connecting part having a flow reducer or diverter included therein. For example and as illustrated schematically in FIG. 10, a breathable-air hose 70 will include a connection 71 for coupling to a transport vehicle's filtered-air nozzle 400. In general, connection 71 is readily coupled (e.g., mechanically, magnetically, etc.) to nozzle 400 such that the filtered-air exiting nozzle 400 (i.e., breathable air 100) enters a single entry port 72 of connection 71. A flow diverter 73 disposed in connection 71 divides the flow of breathable air 100 in connection 71 such that some of the breathable air flows to each of at least two distinct exit ports 74 and 75. A flexible tube 76 is used to couple one of exit ports 74/75 (e.g., exit port 74 in the illustrated embodiment) to inlet port 22 of the present invention's manifold 20 as previously described herein. The remainder of breathable air 100 is dispensed into the ambient environment via exit port 75.

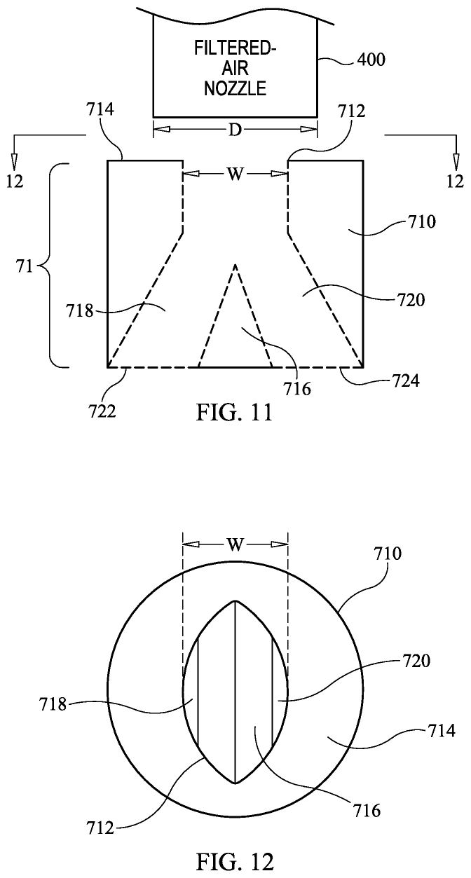

A variety of constructions can be used for connection 71 without departing form the scope of the present invention. By way of a non-limiting illustrative example, one such construction is shown in FIGS. 10 and 11. Connection 71 includes an elastic housing 710 (e.g., rubber, foam, etc.) having an oblong opening 712 at its filtered-air nozzle connecting end 714. The width “W” of oblong opening 712 is generally less than the diameter “D” of filtered-air nozzle 400. A flow path in housing 710 directs air flow there through to a diverter 716 that divides the air flow into two paths 718 and 720. Path 718 terminates in an exit port 722 and path 720 terminates in an exit port 724. In use, housing 710 is simply squeezed to increase the width W of oblong opening 712 thereby allowing housing 710 to be pushed onto filtered-air nozzle 400. Subsequent release of elastic housing 710 allows oblong opening 712 to return to its original state to grip filtered-air nozzle 400.

It is to be understood that any combination of the features described herein could be incorporated into a system of the present invention without departing from the scope thereof. The selected features that are to be combined can be chosen to satisfy one or more application-specific criteria.

The advantages of the present invention are numerous. The present invention provides a face mask wearer with the means to introduce a continuous supply of fresh, filtered, and/or cooled breathable air at their face mask. The system is ideally suited for everyday users to include workers exposed to contaminated/dirty/dusty environments, travelers who are confined to air/land vehicles having enclosed and shared cabin spaces, people who will be exposed to crowded environments such as airports, train stations, bus depots, stadiums or arenas, malls, etc. The system's ability to improve the mask-wearing breathing experience will encourage proper mask wearing for extended periods thereby leading to the health benefits intended by mask wearing. The system can be configured in a variety of ways to support a myriad of application criteria, price points, etc.

Although the invention has been described relative to specific embodiments thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A system for introducing breathable air at a face mask worn by a person, comprising:
a manifold adapted to be worn by a person, said manifold having an inlet port adapted to receive a supply of breathable air, said manifold having an outlet port; and
a flexible conduit having a first open end and a second open end, said first open end coupled to said outlet port of said manifold, and said second open end adapted to be placed between the person's face and a face mask worn by the person.

2. A system as in claim 1, further comprising a housing supporting said manifold.

3. A system as in claim 2, wherein said housing includes a cushion.

4. A system as in claim 1, wherein said flexible conduit at said second end thereof includes a wall configured to adapt to contours of the person's face.

5. A system as in claim 1, wherein said flexible conduit at said second end thereof has an elongate cross-sectional shape.

6. A system as in claim 1, further comprising a retainer coupled to said flexible conduit at said second end thereof, said retainer adapted to engage an edge of a face mask worn by the person.

7. A system as in claim 1, further comprising a sealed gel pack of freezable material disposed in said manifold.

8. A system as in claim 1, further comprising an air filter disposed in said inlet port.

9. A system as in claim 1, further comprising a fan disposed in said inlet port for drawing the breathable air into said manifold.

10. A system as in claim 1, further comprising an air delivery hose that includes:
a connecting portion adapted to be coupled to a transport vehicle's filtered-air nozzle dispensing the supply of breathable air;
a tube for connecting said connecting portion to said inlet port of said manifold;
said connecting portion having a single entry port for receiving the supply of breathable air;
said connecting portion having at least two flow paths therein and in fluid communication with said single entry port, wherein each of said flow paths terminates in an exit port; and
said tube coupled to one said exit port wherein a portion of the supply of breathable air flows through said tube.

11. A system for introducing breathable air at a face mask worn by a person, comprising:
a housing adapted to be worn by a person;
a manifold coupled to said housing, said manifold having an inlet port adapted to receive a supply of breathable air, said manifold having an outlet port; and
a flexible conduit having a first open end and a second open end, said first open end coupled to said outlet port of said manifold, and said second open end adapted to be placed between the person's face and a face mask worn by the person.

12. A system as in claim 11, wherein said housing includes a cushion adapted to partially encircle the person's neck.

13. A system as in claim 11, wherein the face mask has ear loops, and wherein said housing includes ear cushions adapted to engage the ears of the user and adapted to engage the face mask's ear loops.

14. A system as in claim 11, wherein said flexible conduit at said second end thereof includes a wall configured to adapt to contours of the person's face.

15. A system as in claim 11, wherein said flexible conduit at said second end thereof has an elongate cross-sectional shape.

16. A system as in claim 11, further comprising a retainer coupled to said flexible conduit at said second end thereof, said retainer adapted to engage an edge of a face mask worn by the person.

17. A system as in claim 11, further comprising at least one of a sealed gel pack of freezable material disposed in said manifold, an air filter disposed in said inlet port, and a fan disposed in said inlet port for drawing the breathable air into said manifold.

18. A system as in claim 11, further comprising an air delivery hose that includes:
an elastic connecting portion adapted to be coupled to a transport vehicle's filtered-air nozzle dispensing the supply of breathable air;
a tube for connecting said connecting portion to said inlet port of said manifold;
said elastic connecting portion having a single entry port for receiving the supply of breathable air;
said elastic connecting portion having at least two flow paths therein and in fluid communication with said single entry port, wherein each of said flow paths terminates in an exit port; and
said tube coupled to one said exit port wherein a portion of the supply of breathable air flows through said tube.

19. A system for introducing breathable air at a face mask worn by a person, comprising:
a housing adapted to be worn by a person;
a manifold coupled to said housing, said manifold having an inlet port adapted to receive a supply of breathable air, said manifold having at least one outlet port; and
at least one flexible conduit, each said flexible having a first open end and a second open end wherein, for each said flexible conduit, said first open end thereof is coupled to one said outlet port and said second open end thereof is adapted to be placed between the person's face and a face mask worn by the person.

20. A system as in claim 19, further comprising a cushion coupled to said housing, said cushion adapted to partially encircle the person's neck.

21. A system as in claim 19, wherein the face mask has ear loops, said system further comprising ear cushions coupled to said housing, said ear cushions adapted to engage the ears of the person and adapted to engage the face mask's ear loops.

22. A system as in claim 19, wherein each said flexible conduit at said second end thereof includes a wall configured to adapt to contours of the person's face.

23. A system as in claim 19, wherein each said flexible conduit at said second end thereof has an elongate cross-sectional shape.

24. A system as in claim 19, further comprising a retainer coupled to each said flexible conduit at said second end thereof, said retainer adapted to engage an edge of a face mask worn by the person.

25. A system as in claim 19, further comprising at least one of a sealed gel pack of freezable material disposed in said manifold, an air filter disposed in said inlet port, and a fan disposed in said inlet port for drawing the breathable air into said manifold.

26. A system as in claim 19, further comprising an air delivery hose that includes:
an elastic connecting portion adapted to be coupled to a transport vehicle's filtered-air nozzle dispensing the supply of breathable air;
a tube for connecting said connecting portion to said inlet port of said manifold;
said elastic connecting portion having a single entry port for receiving the supply of breathable air;
said elastic connecting portion having at least two flow paths therein and in fluid communication with said single entry port, wherein each of said flow paths terminates in an exit port; and
said tube coupled to one said exit port wherein a portion of the supply of breathable air flows through said tube.
